(19) United States
(12) Patent Application Publication
(10) Pub. No.: US 2006/0086424 A1
(43) Pub. Date: Apr. 27, 2006

(54) Slotter having cutters with adjustable width

(76) Inventors: Gavriel Spector, Kfar Veradim (IL); Igor Berkowitz, Zefat (IL)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 10/513,808

(22) PCT Filed:
(86) PCT No.: PCT/IL03/00349

(30) Foreign Application Priority Data
May 29, 2002 (IL) 149909

(51) Int. Cl. B27G 13/00; B27C 1/00; B27C 5/00

(52) U.S. Cl. 144/237

(57) ABSTRACT

An improvement in a slotter comprising a shank (10) having a distal side and a proximal side, the shank is adapted to be rotated about a rotatory axis at least two adjacently positioned cutters (20, 24) provided with blades (22); and a nut (34) adapted to uphold the cutters (20, 24) on said shank (10). The improvement for adjusting the width of the cutters comprising a hollow bolt (26) adapted to be mounted on the shank wherein one of the cutters is a movable cutter (24) that is screwed on said hollow bolt (26), and a cap (28) mounted on the shank receives a portion of said hollow bolt and confines the movement of the bolt. Adjusting the width of the cutters is established by screwing the movable cutter (24) on said hollow bolt so that the movable cutter gets closer to the other cutter or draws away from it, depending on the direction of the screw.

### FIELD OF INVENTION

The present invention relates to devices for woodworking. More particularly the present invention relates to a slotter for woodworking having cutters with an adjustable width.

### BACKGROUND OF THE INVENTION

Slotters are widely used tools for woodworking in furniture manufacture. A slotter is a rotatable slotting tool for woodworking, which usually has two or several blades attached to it. The slotter is guided, automatically or manually, while rotating at a high speed, through the wood being processed, especially for producing a groove or an edge of a predetermined width or profile on the wood.

Slotters for cutting in general comprise three main parts: the shank, the cutters, and shims. The shank is an elongated shaft adapted to be installed on an automated machine that facilitates rotary motion of the tool. The cutters, usually a pair of cutters, are mounted on the shaft. The cutters have a flat and substantially round body in which a bore through which the shaft is centrally inserted. Each cutter has brazed blades positioned on two opposite sides of the shaft. The blades are slightly broader than the flat body. Shims are provided between the cutters so as to provide the ability to modify the width of the cutters and to allow producing grooves of different profiles using the same slotter.

A disadvantage of using shims in order to vary the cutter's width is the need to disassemble the slotter in order to modify the width of the cutters every time such change is desired. Each type of slotter is provided with a variety of shims having different width. When the width of the slotter does not meet with the user's need, the user has to assemble the slotter and to choose different shim or a few shims in order to obtain the necessary width. It is even necessary in some automatic machines to dismantle the slotter off the machine completely when a modification of the width is needed.

Another drawback of the available slotters is that by using different shims having different width, the modification of the cutter's width is discrete and the width is dependent on the available shims.

There is a need to provide a slotter having adjustable width that is continuous and can be operated quickly and easily without having to dismantle the slotter itself or remove the slotter from the automatic or manual machine.

### BRIEF DESCRIPTION OF THE INVENTION

It is an object of the present invention to provide a slotter having cutters with adjustable width.

It is another object of the present invention to provide a slotter with an adjustable cutting profile that can be changed in a continuous manner without dismantling the blades from the slotter or removing the slotter from a rotatory machine.

It is thus provided in accordance with a preferred embodiment of the present invention, in a slotter comprising a shank having a distal side and a proximal side, the shank is adapted to be rotated about a rotatory axis; at least two adjacently positioned cutters provided with blades; and a nut adapted to uphold the cutters on said shank, an improvement for adjusting the width of the cutters comprising a hollow bolt adapted to be mounted on the shank wherein one of the cutters is a movable cutter that is screwed on said hollow bolt, and a cap mounted on the shank receives a portion of said hollow bolt and confines the movement of the bolt,

whereby adjusting the width of the cutters is established by screwing the movable cutter on said hollow bolt so that the movable cutter gets closer to the other cutter or draws away from it, depending on the direction of the screw.

Furthermore, in accordance with a preferred embodiment of the present invention, one of the cutters that is a fixed cutter is firmly screwed on a portion of the shank that is provided with a screw.

Furthermore, in accordance with a preferred embodiment of the present invention, a bearing is further provided on the shank, said bearing limits the depth of penetration of the cutters and wherein said bearing is separated from an adjacent fixed cutter by a washer.

Furthermore, in accordance with a preferred embodiment of the present invention, said hollow bolt comprises a quadrangle-shaped head that is received in a corresponding dent provided in the cap.

Furthermore, in accordance with a preferred embodiment of the present invention, a washer is provided on a rim about an edge on said hollow bolt, the washer is positioned adjacent to the cutters.

Furthermore, in accordance with a preferred embodiment of the present invention, the nut is screwed on a portion of the shank that is provided with a screw and is adjacent to the cap.

Furthermore, in accordance with a preferred embodiment of the present invention, a ruler is marked on an adjustable surface on the cutter, the ruler marks the width of the cutters so that a user can accurately modify the width of the cutters.

### BRIEF DESCRIPTION OF THE FIGURES

FIG. 1 illustrates an exploded view of the parts comprising a slotter having an adjustable width in accordance with a preferred embodiment of the present invention.

FIG. 2 illustrates a side view of the slotter shown in FIG. 1, in an assembled state.

FIG. 3a illustrates a cross sectional view of the assembled slotter shown in FIG. 1, in a maximal deployment.

FIG. 3b illustrates a cross sectional view of the assembled slotter shown in FIG. 1, in a minimal deployment.

### DETAILED DESCRIPTION OF THE PRESENT INVENTION AND FIGURES

The present invention provides a novel design of a slotter having cutters with adjustable width, suitable for industry, workshops, craftsmen and do-it-yourself carpenters.

It is provided in accordance with a preferred embodiment of the present invention, a slotter having cutters with adjustable width comprising a shank having a distal side and a proximal side. The proximal side of the shank is designed to be mounted on an automated machine providing a rotatory motion, and rotated about a rotatory axis, and the distal side is coupled to the cutters. Usually, there are two adjacent cutters facing each other and maintaining a predetermined distance between them so as to establish a predetermined width for the slotter, when it cuts into the board to be processed; hence a predetermined profile. In the preferred embodiment of the present invention, one of the cutters is fixed on the shank and the other cutter is can be moved along the longitudinal axis of the shank so that by moving the movable cutter away from the fixed cutter, the width of the cutters increases and by moving the movable cutter closer to the fixed cutter, the width of the cutters decreases.

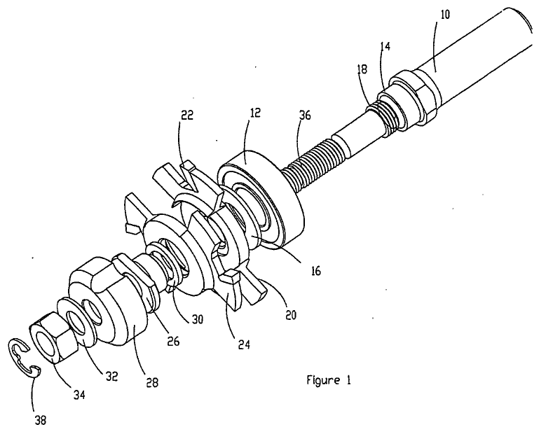

Reference is now made to FIG. 1, illustrating an exploded view of the parts comprising a slotter having an adjustable width in accordance with a preferred embodiment of the present invention. The slotter comprises an elongated shank 10 having a distal end and a proximal end. The proximal end is adapted to be connected to an automatic or manual machine that provides rotatory motion to shank 10. The distal end of shank 10 is adapted to carry-the cutters and adjustable means that will be comprehensively explained hereinafter.

Portions of the distal side of shank 10 are provided with screws on which parts of the slotter are adapted to be screwed and fixed. A bearing 12 is provided on a corresponding rim 14. Bearing 12 is adapted to determine the penetration depth of the blades when performing a cut and to prevent the blades from being inserted further into the material that is processed. A washer 16 is screwed on screw 18 so as to detain bearing 12, and an upper cutter 20 is screwed adjacently to washer 16. Cutter 20 is screwed to shank 10; hence, it is a static cutter. Cutter 20 comprises an annular and flat body that is mounted on shank 10 and protruded portions on which blades 22 are provided. The protruded portions are structured so that a portion of the blade is positioned in a dent so as to allow splinters to be conveniently disposed and cleared away during operation.

Cutter 24 that has similar structure as cutter 20 and can be slided along shaft 10 and fixed in a desired position so as to establish an adjustable distance between the cutters. Cutter 24 is screwed on a hollow bolt 26 that is mounted on shaft 10, on a portion of the shaft that is smooth. The movement of cutter 24 along the shaft can be established by screwing the cutter about hollow bolt 26 so that cutter 24 can be moved closer to cutter 20 or drawn away from it. In this manner, the overall effective cutters' width can be modified.

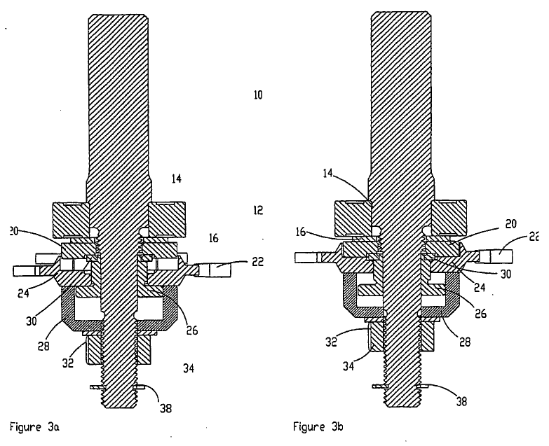

In order to better understand the ability to adjust the width of the cutters by turning cutter 24 about hollow bolt 26, reference is now made to FIG. 3a and FIG. 3b. FIGS. 3a and 3b illustrate cross sectional views of the assembled slotter shown in FIG. 1. The set width of the cutters in FIG. 3a is maximal while the set width is minimal in FIG. 3b. It is clearly shown that cutter 20 is directly screwed on shaft 10 so that this cutter is static while cutter 24 is screwed on hollow bolt 26 that can move along shaft 10 so that cutter 24 moves along the shaft as well. Cutter 24 is movable, and can be moved closer to cutter 20 or to be withdrawn so as to establish a substantial distance between the cutters.

Returning to FIG. 1. In order to support and retain hollow bolt 26 on shaft 10, a cap 28 is provided and mounted on shaft 10 as well as a washer 30. Washer 30 is positioned on a rim provided on the edge of hollow bolt 26 and is adjacent to the cutters. The washer prevents hollow bolt 26 from dismantling and supports the cutters. Cap 28 receives the main portion of hollow bolt 26 that includes the bolt's head. The head of the bolt can be square or quadrangle and is restrained in a corresponding square or quadrangle dent in the inner part of cap 28. An additional washer 32 is mounted on shaft 10 and a nut 34 is screwed on another portion of shaft 10 that is provided with a screw 36 so as to assemble the parts of the slotter together. A closure 38 is also provided.

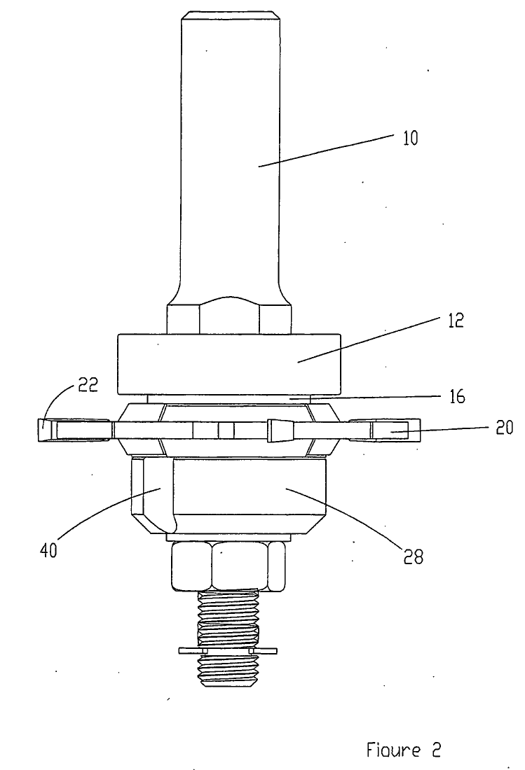

Reference is now made to FIG. 2 illustrating a side view of the slotter shown in FIG. 1, the slotter shown in an assembled state. The function of bearing 12 in determining the dept of the cut made by cutters 20 and 24 is clearly shown since the cut is made laterally with respect to the tool's longitudinal axis. The cutters cannot penetrate into the wood or the other material to be processed more that the distance between the cutters edges and the bearing. The bearing also protects cap 28 from being damaged, since the cap's edges is further internally positioned than the bearing's edges.

It is optional to provide a ruler onto cap 28 and a marker 40 that is adapted to indicate the overall width of the cutters that represents also the cut's profile. When the user wants to establish a predetermined width, he may adjust the tool's width according to the ruler.

A very important feature in the slotter of the present invention in comparison to previous tools is the ability to modify the cutters width continuously. In slotters that are used nowadays, the width is determined by the width of the shim that is provided between the cutters. Each shim provides a specific distance between the cutters; hence, a specific width. In order to modify the width of the cutter, the shim has to be changed. In the slotter of the present invention, in order to modify the cutters width, the cap has to be turned so that the movable cutter moves along the shaft and gets closer to the static cutter or draws away from it. In this manner, as explained herein before, the distance between the cutters is established. The distance between the cutters; hence the overall width of the cutters can be continuously modified by turning the movable cutter away from or closer to the static cutter. Another advantage in the slotter of the present invention is that the width is modified without the need to dismantle the tool. In the existing tools, it is necessary to dismantle the tool in order to change the shim and modify the width of the cut. As shown herein before, a marker and a ruler provided on the cap can indicate the exact width of the cutters so as to ease the width modification.

It should be clear that the description of the embodiments and attached Figures set forth in this specification serves only for a better understanding of the invention, without limiting its scope.

It should also be clear that a person in the art, after reading the present specification could make adjustments or amendments to the attached Figures and above described embodiments that would still be covered by the present invention.

1. In a slotter comprising a shank having a distal side and a proximal side, the shank is adapted to be rotated about a rotatory axis; at least two adjacently positioned cutters provided with blades; and a nut adapted to uphold the cutters on said shank, the improvement for adjusting the width of the cutters comprising a hollow bolt adapted to be mounted on the shank wherein one of the cutters is a movable cutter that is screwed on said hollow bolt, and a cap mounted on the shank receives a portion of said hollow bolt and confines the movement of the bolt,
whereby adjusting the width of the cutters is established by screwing the movable cutter on said hollow bolt so that the movable cutter gets closer to the other cutter or draws away from it, depending on the direction of the screw.

2. The slotter as claimed in claim 1, wherein one of the cutters that is a fixed cutter is firmly screwed on a portion of the shank that is provided with a screw.

3. The slotter as claimed in claim 1, wherein a bearing is further provided on the shank, said bearing limits the depth of penetration of the cutters and wherein said bearing is separated from an adjacent fixed cutter by a washer.

4. The slotter as claimed in claim 1, wherein said hollow bolt comprises a quadrangle-shaped head that is received in a corresponding dent provided in the cap.

5. The slotter as claimed in claim 1, wherein a washer is provided on a rim about an edge on said hollow bolt, the washer is positioned adjacent to the cutters.

6. The slotter as claimed in claim 1, wherein the nut is screwed on a portion of the shank that is provided with a screw and is adjacent to the cap.

7. The slotter as claimed in claim 1, wherein a ruler is marked on an adjustable surface on the cutter, the ruler marks the width of the cutters so that a user can accurately modify the width of the cutters.

8. A slotter substantially as described in the above specification, attached Figures and appending Claims.
